(19) United States
(12) Patent Application Publication
(10) Pub. No.: US 2020/0269331 A1
(43) Pub. Date: Aug. 27, 2020

(54) DEBURRING TOOL

(71) Applicant: Guehring KG, Albstadt (DE)

(72) Inventors: Ingo V. Puttkamer, Albstadt (DE); Felix REBHOLZ, Frohnstetten (DE)

(73) Assignee: Guehring KG, Albstadt (DE)

(21) Appl. No.: 16/739,481

(22) Filed: Jan. 10, 2020

Related U.S. Application Data
(63) Continuation of application No. PCT/DE2018/000212, filed on Jul. 11, 2018.

(30) Foreign Application Priority Data
Jul. 11, 2017 (DE) 10 2017 115 540.6

(51) Int. Cl. B23B 51/10

(52) U.S. Cl. CPC B23B 51/101; B23B 51/104; B23B 2226/27; B23B 2220/08; B23B 51/105

(57) ABSTRACT

A deburring tool (10) for deburring at least one through-hole (24) in a workpiece, the surface (38) of the through-hole (24) to be deburred located on the side away from the deburring tool (10), the tool comprising a main body (12) with a tool shaft (14) and a tool head (16), the tool shaft (14) having a clamping section (16) and the tool head (16) having a guide section (20) with a guide sleeve (22) extending along or parallel to an axis of rotation (36). The tool head (16) comprises at least one flexible fibre (26) with an abrasive surface (28), which is permanently or detachably attached in the guide sleeve (22), the fibre (26) having a free length (L1) and the guide sleeve (22) having a length (L2), the free length (L1) and/or the length (L2) corresponding to at least the depth (T) of the through-hole (24).

The invention relates to a deburring tool for debarring or countersinking at least one through-hole in a workpiece, the surface of the through-hole to be. debarred being arranged on the side facing away from the debarring tool.

Furthermore, the invention relates to a method for debarring using a debarring tool in this regard.

### STATE OF THE ART

Debarring tools. are known from the Prior art with which surfaces of a through-hole can be debarred, wherein the surface to be debarred is arranged on the side facing away from the workpiece with respect to the debarring tool.

Especially for holes having smaller diameters, it is known to use so-called reverse countersinks to deburr or touch difficult-to-access surfaces. The aircraft and aerospace industry also places the highest demands. on a burr-free, aerodynamic surface finish, which requires a large number of debarring machining operations, in particular through reverse deburrings.

For example, DE 843 79 38 U1 shows a reverse countersink with a pivotable, oscillating, suspended drive motor, wherein the motor is able to move a debarring cutter with at least one cutter on a shaft. It can be guided to the edge of the hole to be debarred by to the movably guided cutter.

DE 10 2013 108 232 A1 shows a further reverse countersink with a removable tool head and tool shaft, wherein the tool shaft is to be inserted through the through-hole from the side on which the countersink is to be introduced and is connected to it from the side of the machine tool, so that the clamping and unclamping operations take place, on the machine tool and the reverse countersinking tool must be inserted into the. through-hole from the machining side and removed again.

There is the problem that such deburring tools, in particular reverse countersinks, consist of many individual elements or components and are therefore complex and costly to produce.

In addition, there is the problem that, for different hole diameters, either different reverse countersunk heads have to be mounted, or a complex construction has to be carried out to implement an adaptable reverse countersunk head. Furthermore, when the, tool is used, assembly is carried out. from both sides of the workpiece, so that the workpiece must be accessible from both sides.

The object of the invention is therefore to propose. a deburring tool. which is characterized by simple and inexpensive production and a flexible adaptation of the deburring region to different through-holes, wherein through-holes that are accessible only from one side of the workpiece can also be deburred.

This task is achieved by a deburring tool according to the independent claims. Advantageous further developments of the invention are the subject of the dependent claims.

### DISCLOSURE OF THE INVENTION

The invention relates to a deburring tool for deburring at least one through-hole in a workpiece, the surface of the through-hole to be deburred being arranged on the side facing away from the deburring tool, comprising a main body having a tool shaft and a tool head. The tool shaft comprises a clamping section and the tool head a guide section with a guide sleeve extending along or parallel to an axis of rotation.

It is proposed that the tool head have at least one flexible fiber having an abrasive fiber surface which is permanently or detachably fixed in the guide sleeve, the fiber having a free length (L1) and the guide sleeve having a length (L2), the free length (L1) and/or the length (L2) corresponding at least to the depth (T) of the through-hole.

In other words, the invention relates to a reverse countersinking tool or a reverse deburring tool that is suitable for deburring or countersinking a through-hole that is to be deburred on the opposite side of the workpiece with respect to the machine tool. Using a deburring tool according to the invention, a through-hole can therefore be deburred or countersunk on the side which is not visible to an operator who is located on the side of the machine tool, that is, is facing away. This also applies to the case in which the operation is not carried out by an operator, but by a robot, wherein deburring is to take place on the side facing away from the robot. In both cases, deburring or countersinking can take place on an inaccessible side of the workpiece. All machining or components necessary for machining the opening surface of the through-hole or the surface of the workpiece are accordingly passed through the through-hole for the machining state from one side, which represents the side of the machine tool, and removed again in the same way. For this purpose, the deburring tool according to the invention has a tool shaft having a clamping section for clamping in a machine tool, and a tool head consisting of at least one guide section and a fiber. The fiber is formed from a flexible material and can be moved away from the position of the rest position of the fiber by rotation. The fiber can be arranged in the extension of the guide section on the tool head. The guide section is used to clamp the fiber and is configured as a guide sleeve The guide sleeve is preferably also filled with material in the inside, wherein the guide sleeve can be configured as a round rod. The fiber and the guide sleeve can have the same or a different length. The fiber can have a smaller cross-sectional size than the guide sleeve or can also be configured with an identical cross-section as an extension to the guide sleeve. Likewise, the fiber can have a larger crosssectional size than the cross-sectional size. of the guide sleeve. When the deburring tool is rotated by a machine tool, the guide section with the guide sleeve therefore remains on the axis of rotation, while the fiber experiences a deflection as a function of the rotational speed and the length of the fiber. On the one hand, the fiber can have a free length that corresponds at least to the depth of the through-hole. It is also advantageous when the length of the guide section and thus the length of the guide sleeve corresponds at least to the depth of the through-ho/e. On the one hand, this enables the surface of the workpiece opposite the machine tool to be reached with the fiber. Furthermore, it is ensured that in the event of a longitudinal displacement of the deburring tool with respect to the axis of rotation of the deburring tool, there can be contact between the fiber surface and the opening surface of the through-hole to be deburred or countersunk over a certain time period. The deburring tool is configured to carry out deburring or countersinking of a through-hole via a contact between the fiber surface of the fiber and the surface to be deburred. The countersink angle is influenced by the rotational speed and the axial travel speed of the tool.

The machining takes place via the abrasive effect through a friction between the fiber surface and the workpiece surface, which is generated by a rotation of the machine tool and the deburring tool with an axial reverse movement of the tool in the removal direction of the through-hole. The entire surface of the fiber is available to achieve material removal, wherein the entire surface can be guided to the point to be deburred, at least on one long side of the fiber, by a longitudinal displacement of the deburring tool in the direction of the axis of rotation of the deburring tool. The deburring tool is preferably displaced longitudinally parallel to a rotation of the deburring tool. The fiber preferably has a round cross-section. Likewise, the fiber can be exchangeably mounted in the guide sleeve, wherein only a rotation of the fiber with respect to the relaxation in the guide sleeve is also able to bring another section of the fiber surface into contact with an opening surface to be machined. The deburring tool is also configured to fix or clamp fibers of different lengths, that is, fibers having different free lengths, in the guide sleeve. The machining angle, that is, the angle of the deburred or countersunk region, can be influenced via the free length of the fiber and the rotational speed.

In a preferred embodiment, the fiber can be guided within the guide sleeve along the axis of rotation. This thereby achieves the fiber being arranged in direct extension to the guide sleeve and being arranged in a rest position on the axis of rotation of the deburring tool. When the deburring tool rotates, there is no imbalance with respect to the tool head due to deflection of the fiber. The accuracy or symmetry of the countersink generated or during deburring can thus be improved or ensured.

In a preferred embodiment, at least two flexible fibers can be guided in the guide sleeve parallel to the axis with respect to the axis of rotation, wherein both fibers preferably have the same free length (L1). The two fibers are preferably arranged symmetrically with respect to an axis bisecting the cross-section of the cross-section of the guide sleeve, wherein this axis preferably runs through the axis of rotation. Accordingly, both fibers are preferably arranged at the same distance from the axis of rotation, which can also prevent an imbalance when the deburring tool rotates. It is advantageous to configure both fibers with the same length and the same cross-section, so that a symmetrical mass distribution on the tool head can be ensured.

In a preferred embodiment, at least three fibers, in particular four to seven fibers, can be arranged on the guide sleeve in an evenly distributed manner about the axis of rotation in the circumferential direction, wherein all fibers preferably have the same length (L1). In this case, the fibers are preferably arranged with respect to the cross-section of the guide sleeve such that when the tool rotates due to the deflection of the individual fibers due to the. centrifugal force, no imbalance is generated on the tool head. A plurality of fibers present can strengthen the abrasive effect of the deburring tool and reduce the machining time during a rotational movement of the deburring tool and the contact of the individual fibers with the surface to be deburred. Likewise, a balance is established at the tool head during rotation due to the evenly distributed individual fibers, and the service life of the tool is increased.

In a preferred embodiment, the fiber can be formed at least in sections as plastic fiber, glass fiber, metal fiber, ceramic fiber and/or carbon fiber. The fiber can be produced entirely from one material or consist of sections of different material properties. The sections can be divided with respect to the length of the fiber as well as with respect to the cross-section of the fiber. A fiber can thus also be. formed over the entire length in a cross-sectional half with a first material and in a second cross-sectional half with a different material. If the fiber is torque-proof in the guide sleeve, that is, firmly fixed, the cross-sectional half of the fiber which is external during rotation can consist of a particularly abrasive material, and the region of the fiber which is internal during rotation can be, formed of a less expensive or other material. The two so-called material halves can also have different sizes, for example, wherein the section made of an abrasive material can only make up a third of the cross sectional area of the fiber and also only a third of the volume of the fiber.

In a preferred embodiment, the fiber can be configured as a bundle of individual filaments, that is, as a multi- filament, or as an individual filament, that is, as an individual filament. If the fiber consists of individual filaments, these can form the fiber twisted against one another, creating a structured fiber surface. This can strengthen the abrasive effect.

In a preferred embodiment, the fiber surface of the fiber can be configured structured or textured in order to provide the abrasive effect on contact with the workpiece. A wave or nub structure or some other structure can be present on the fiber surface. The structure can also be configured only in subregions of the fiber surface, wherein these subregions, are preferably in contact with the workpiece surface to be machined with a rotational movement of the deburring tool.

In a preferred embodiment, a weight can be fastened to the front end of the fiber, wherein the cross-sectional size of the weight is, preferably less than or equal to the cross-sectional size of the fiber. The weight can ensure that with a rotational movement of the deburring tool, the fiber is tensioned at all times as soon as it experiences a deflection from the rest position. The pressure between the fiber surface and the opening surface to be machined can be strengthened during machining, which strengthens the abrasive effect and minimizes the machining time. The weight can be a metal sleeve which is arranged at the fiber end.

In a preferred embodiment, the length of the guide sleeve can be changeably adjustable, in particular telescopic lengths are changeable. The extension can take place, for example, in the region of relaxation in the guide sleeve. This enables through-holes of different depths to be reached with the fiber on the opening surface to be machined and thus being machinable.

In a preferred embodiment, the at least one fiber can be exchangeably mounted in the guide sleeve. When the fiber wears, the entire main body, consisting of the tool shaft and tool head, does not have to be replaced or disposed of. The fiber can be tensioned in the guide sleeve and can preferably be replaced by actuating an advantageously spring-loaded, tensioning mechanism, in particular without tools.

In a preferred embodiment, a stop can be arranged on the guide section, which stop can execute a rotational movement relative to the guide sleeve, wherein the stop has a larger diameter than the largest diameter of the through-hole. Since the opening surface to be machined is located in. a region that is not visible to the machine tool, the stop can ensure that a predefined countersink or a predefined deburring machining can be carried out.

In a preferred embodiment, the stop can have a stop ring and a stop sleeve. The stop can therefore be formed from individual elements which can be moved against one another. Differently configured stop rings can thus be attached to a stop sleeve

In a preferred embodiment, the stop ring can execute a rotational movement relative to the stop sleeve, wherein the stop sleeve is preferably mounted in a torque-proof manner with the guide sleeve and the stop ring is preferably mounted on the stop sleeve via a pivot bearing. The stop sleeve is preferably connected directly to the guide sleeve or telescopically pushed onto it, wherein the stop ring can make contact with a workpiece surface in order to determine and maintain the machining depth or machining position. The stop ring is arranged on an axial end of the stop sleeve so as to pivot on it.

In a preferred embodiment, the stop and the guide sleeve can be displayable relative to one another, in particular telescopically, in the axial direction of the axis of rotation. Different machining depths can thus be set. This is an advantage when through through-holes of different depths are to be machined in workpieces of different depths. The stop can be in contact with the workpiece surface on the side of the machine tool over the entire machining time, while the fiber and the guide sleeve experience a longitudinal displacement with respect to the axis of rotation of the. deburring tool. Accordingly, the machine tool also experiences this longitudinal displacement. The fiber can thus be pushed out of the stop to different extents.

In a preferred embodiment, the stop sleeve can be guided axially along the guide sleeve by a guide pin, which is arranged radially on the stop sleeve, and a guide slot, which is preferably introduced in the axial longitudinal direction on the guide sleeve, wherein the guide pin engages in the guide tip. This ensures that only a relative longitudinal displacement between the guide sleeve and the stop sleeve can take place, while a relative rotational movement of these two elements against one another is prevented.

The invention further relates to a method for deburring using a deburring tool according to the invention. It is proposed that the method be characterized by the following steps:
inserting the deburring tool into a through-hole from an opposite side of the workpiece with respect to an opening surface to be deburred, wherein at least the fiber partially protrudes from the through-hole on the surface to be deburred,
rotating the deburring tool to the nominal speed, wherein the at least one fiber preferably strives away at right angles with respect to the guide sleeve due to the centrifugal force,
pulling the deburring tool out of the through-hole during the rotational movement of the deburring tool, so that deburring and machining is effected on the surface of the through-hole, wherein the deburring angle depends on the speed and the longitudinal movement of the deburring tool.

A rotational movement of the deburring tool can take place from the point in time when the fiber is located in the position in which it protrudes from the workpiece on the surface to be machined. This rotational movement can be maintained until the fiber is completely pulled out of the through-hole, or can be interrupted earlier.

Among other things, this allows a determination of which part of the fiber surface is deburred. If there is a rotation until the deburring tool is completely pulled out of the through-hole, a deburring effect ensues over the entire length of the fiber, that is, over the length of the fiber surface. If, on the other hand, the debarring tool is only rotated in a certain subsection of the method, a deburring effect occurs only with this section of the fiber surface which comes into contact with the opening surface to be machined during the rotational movement.

In a preferred embodiment of the method, the fiber surface of the fiber comes into contact with the surface of the through-hole to be deburred during the rotational movement about the axis of rotation, wherein a debarring effect takes place through the fiber surface. Since the fiber consists of a flexible material, it is deflected by the centrifugal force from the rest position with a rotational movement of the deburring tool. The fiber can be deflected up to an angle of 90° with respect to the longitudinal axis of the guide sleeve. If the deburring tool is now displaced in the longitudinal direction such that the fiber or the fiber surface comes into contact with the opening surface for debarring, there is an abrasion effect between the fiber surface and the surface of the workpiece. Material is thus removed, which constitutes a countersink or deburring of this region.

In a preferred embodiment of the method, the speed of the deburring tool and/or the free length of the fiber can be adjusted for setting a tensile stress in the fiber. This allows the amount of material removal to be determined and the deburring angle to be set.

In a preferred embodiment of the method, the workpiece can be a plastic, composite fiber or lightweight board.

Accordingly, the material of the fiber can be adapted to the material properties to be machined. Likewise, the surface quality of the fiber can be structured to different strengths, partially structured or configured smooth for different materials to be machined.

### DRAWINGS

Further advantages result from the present description of the drawing. Embodiments of the invention are illustrated in the drawings. The drawings, description, and claims contain numerous features in combination. The person skilled in the art will expediently also consider the features individually and combine them into useful further combinations.

Shown are:

FIGS. 1A, IB, 1C, 1D, 1E and 1F a representation of several method steps of a method for deburring using a deburring tool according to the invention;

FIG. 2 a schematic sectional illustration of a longitudinal section through an embodiment of a deburring tool according to the invention in two method steps;

FIG. 3 a schematic sectional illustration of a longitudinal section through an embodiment of a deburring tool according to the invention with a stop;

FIGS. 4A and 4B an illustration of an embodiment of a deburring tool according to the invention;

FIGS. 5A and 5B a representation of an embodiment of a deburring tool according to the invention in longitudinal section and external view;

FIGS. 6A and 6B a representation of an embodiment of a deburring tool according to the invention in longitudinal section and external view;

FIG. 7 en illustration of an embodiment of a deburring tool according to the invention;

FIG. 8 a detail from FIG. 7 in an isometric illustration;

FIGS. 9A, 9B, 9C and 9D different top views of different embodiments of tool heads in the direction of the longitudinal axis of different embodiments of deburring tools according to the invention having a different number of fibers.

In the figures, identical or similar components are numbered with the same reference numerals.

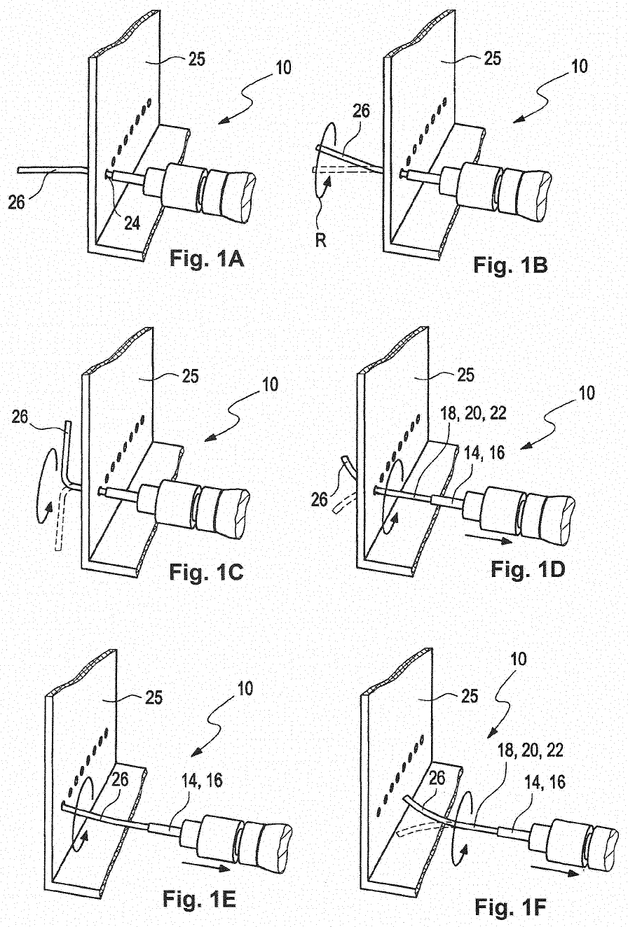

FIGS. 1A, 1B, 1C, 1D, 1E and 1F show various method steps of the method for deburring using a deburring tool according to the invention. In the illustrated embodiment, the debarring tool 10 has a fiber 26 which is configured many times longer than the thickness of the workpiece 25, that is, than the depth T of the through-hole 24, and is arranged on the axis of, rotation of the deburring tool 10. The fiber 26 is clamped on the tool head 18 via a guide section 20 configured as a guide sleeve 22. The tool shaft 14 has a clamping section 16 with which it can be clamped in a machine tool. Furthermore, in the illustrated embodiment of the deburring tool 10, the guide sleeve 22 is designed longer than the thickness of the workpiece 25. In the step depicted in FIG. 1A, the deburring tool 10 is inserted into a through-hole 24 which has been introduced into a workpiece 25. The deburring tool 10 is guided into the through-hole 24 such that the fiber 26 on the opposite side of the workpiece 25 protrudes from the through-hole 24 with respect to the deburring tool 10, so that the fiber surface 28 can make contact with the opening surface 38 to be deburred (not visible in this view). In the step depicted in FIG. 1B, the deburring tool 10 is now rotated so that the fiber 26 experiences a deflection through the rotational movement R with respect to the longitudinal axis of the deburring tool 10. Upon reaching a nominal speed, illustrated in the step depicted in FIG. 1C, the fiber 26 is arranged essentially at right angles with respect to the guide sleeve 22 due to the centrifugal force. In the step depicted in FIG. 1D, the deburring tool 10 is moved longitudinally in the direction of the axis of rotation (to the right in the arrangement illustrated), so that the free length of the fiber 26 is drawn through the through-hole 24. In this case, the fiber 26 having the fiber surface 28 is in contact with the opening surface 38 of the through-hole 24 to be debarred, by which the deburring effect is achieved. During the longitudinal displacement of the deburring tool 10, the fiber 26 exerts a rotational movement R using the deburring tool 10. In the step depicted in FIG. 1E, the fiber end has almost reached the through-hole 24 due to the longitudinal displacement, so that the fiber 26 is only minimally deflected from the axis of rotation 36. The rotational movement R is terminated in this embodiment only when the deburring tool 10 has been completely moved out of the through-hole 24, in the step depicted in FIG. 1F. The workpiece 25 can constitute a plastic, composite fiber or lightweight board.

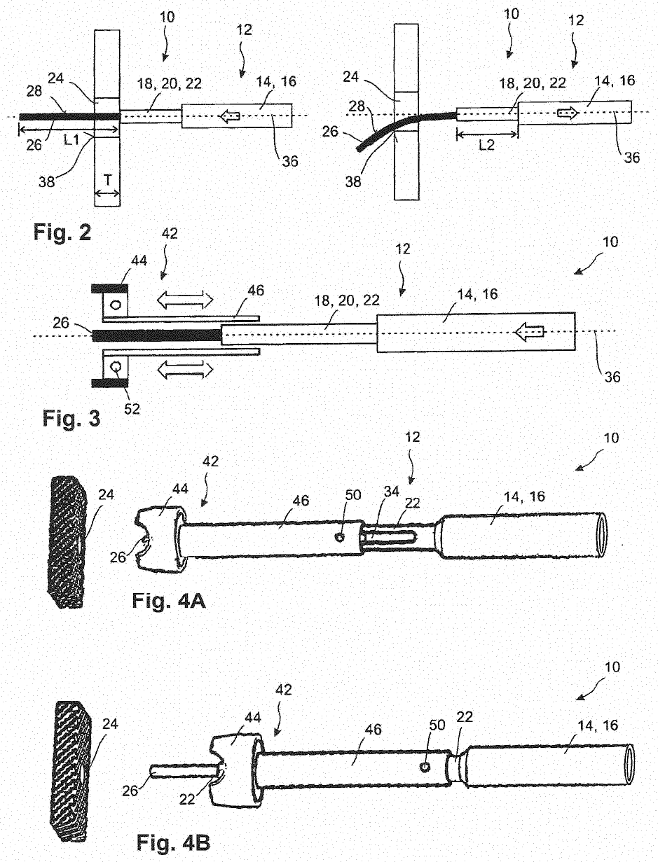

FIG. 2 shows a schematic sectional illustration of a longitudinal section through an embodiment of a deburring tool 10 according to the invention, wherein the deburring tool 10 is illustrated for two different method steps. The left representation illustrates the step depicted in FIG. 1A, the right representation the step depicted in FIG. 1A. It can be seen from FIG. 2 that the length L1 of the fiber 26 and the length L2 of the guide sleeve 22 is configured many times longer than the depth T of the through-hole 24. Furthermore, it is clear that in the illustration on the right the fiber surface 28 is in contact with the opening surface 38 for deburring in such a way that deburring or countersinking of the through-hole 24 can be achieved. The deburring tool 10 is arranged in the through-hole 24 or on the central axis of the through-hole 24 such that the remaining section of the free length of the fiber 26 is not in contact with the surface of the through-hole 24. If the deburring tool 10 is moved to the right in the illustration on the right, the opening surface 38 to be deburred is in contact with the fiber surface 28 over the entire displacement path or displacement period. A schematic sectional illustration of a longitudinal section through an embodiment of a deburring tool 10 according to the invention is illustrated with a stop 42 in FIG. 3. The main body 12, consisting of tool shaft 14 and tool head 18, is configured to be displaceable in the longitudinal direction relative to the axis of rotation of the deburring tool 10 against the stop 42. As a result, the fiber 26 can also be displaced in the longitudinal direction of the deburring tool 10 in such a way that it protrudes to different extents beyond the stop 42 (on the left in the illustration). The stop 42 consists of a stop sleeve 46 and a stop ring 44, wherein the stop ring 44 and the stop sleeve 46 are mounted with one another via a pivot bearing 52. The pivot bearing 52 can be configured as a roller bearing or plain bearing, and therefore as a ball bearing, As a result, the stop ring 44 can execute a rotational movement with respect to the stop sleeve 46, wherein the stop sleeve 46 is mounted in a rotationally fixed manner with the guide section 20 in the form of a guide sleeve 22.

FIGS. 4A and 4B show an external view of a deburring tool 10 according to FIG. 3. The deburring tool 10 is centrally aligned on a through-hole 24. FIG. 4A shows a situation in which the fiber 26 is arranged almost completely within the stop 42. In FIG. 4B, the fiber 26 at least partially projects beyond the stop 42. The stop 42 is displaced relative to the main body 12 via a guide pin 50 which runs in a guide slot 34, wherein the guide slot 34 is arranged in the guide sleeve 22 in the longitudinal direction. The length of the guide slot 34 determines the maximum possible longitudinal displacement of the stop 42 relative to the main body 12.

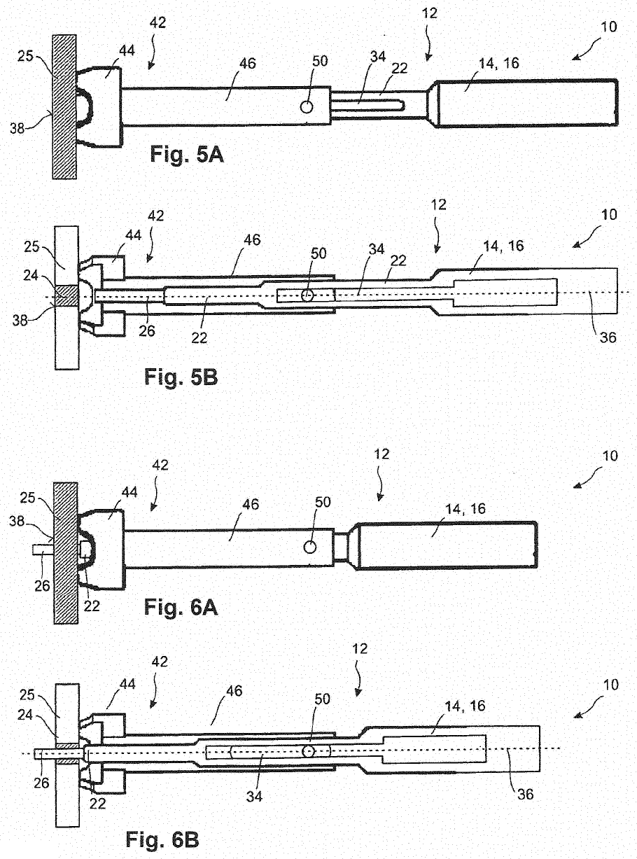

FIGS. 5A and 5B show an arrangement in which the stop 42 is in contact with a workpiece 25 such that the fiber 26 is arranged centrally with respect to the through-hole 24. This is illustrated by the sectional view in FIG. 5B. Accordingly, the axis of rotation 36 and the axis of the through-hole 24 lie on one line in this illustration.

The situation after the fiber 26 has been extended into the throughhole 24 is shown in FIGS. 6A and 6B, wherein it is clarified in FIG. 6B that the free length of the fiber 26 is configured longer than the depth of the through-hole 24. In the view illustrated, the fiber 26 therefore completely engages in the through-hole 24, while the guide sleeve 22 is arranged outside the through-hole 24.

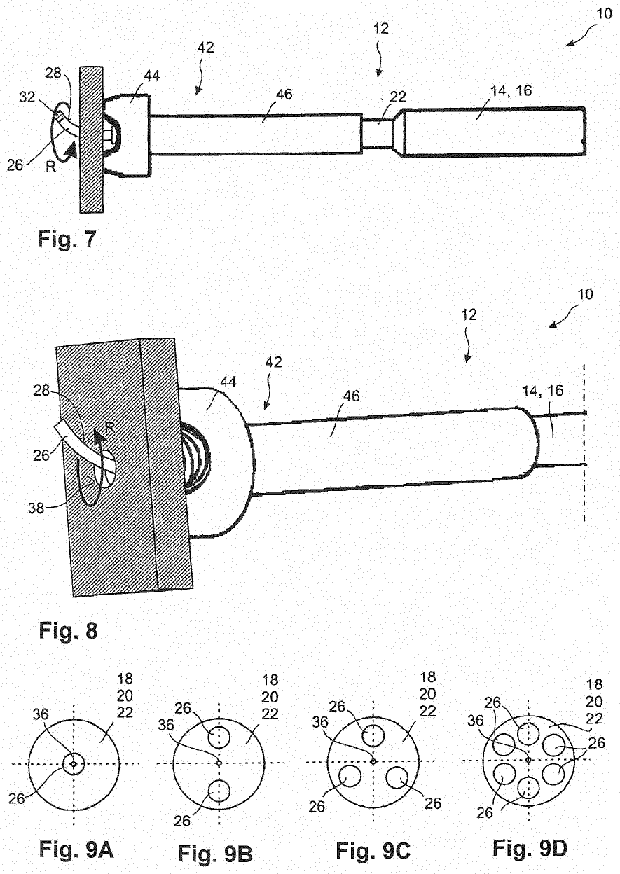

FIGS. 7 and 8 show a situation according to FIG. 6A and 6B, wherein the fiber 26 performs a rotational movement R.

In the embodiment of the deburring tool 10 according to FIG. 7, a weight 32 is arranged at the end of the fiber 26. The weight 32 has a small dimension compared to the length of the fiber 26, wherein the crosssectional size of the weight 32 is configured less than or equal to the cross-sectional size of the fiber.

The isometric representation in FIG. 8 shows how the fiber surface 28 comes into contact with the opening surface 38 to be deburred during a rotational movement R, wherein the entire opening surface 38 to be deburred is touched by the fiber surface 28 once in the circumference during a rotational movement R through 360°.

FIGS. 9A, 9B, 90 and 9D show different top views of different embodiments of tool heads of deburring tools 10 according to the invention, wherein the different deburring tools 10 have a different number of fibers 26. FIG. 9A shows an embodiment of a deburring tool 10 according to the invention which has only one fiber 26. The fiber 26 is arranged centrally on the axis of rotation 36 and is guided in the guide sleeve 22, which constitutes the guide section 20 of the tool head 18. In the embodiment according to FIG. 9B, the deburring tool 10 according to the invention have two fibers 26 which are arranged symmetrically with respect to a transverse axis which runs through the axis of rotation 36 of the deburring tool 10. Likewise, the two fibers 26 are arranged symmetrically with respect to the axis of rotation 36, so that during a rotational movement of the deburring tool 10, no imbalance is exerted on the guide sleeve 22 by the centrifugal force of the two fibers 26. FIG. 9C shows an embodiment of a deburring tool according to the invention having three fibers 26, wherein all three fibers 26 are clamped and fixed in the guide sleeve 22 at the same distance from one another. Such an arrangement can also prevent an imbalance on the tool head 18 during a rotational movement of the deburring tool 10. In the embodiment according to FIG. 9D, the deburring tool 10 according to the invention has six fibers 26, wherein all fibers 26 about the axis of rotation 36 in the circumferential direction are arranged in an evenly distributed manner about the axis of rotation 36 on the guide sleeve 22.

In all embodiments according, to FIGS. 9A, 9B, 9C, and 9D, the respective fibers 26 can each have the same length or can be configured with different lengths and can be installed interchangeably. However, all the fibers 26 of a deburring tool 10 preferably have the same length.

### LIST OF REFERENCE NUMBERS

10 deburring tool

12 main body

14 tool shaft

16 clamping section

18 tool head

20 guide section

22 guide sleeve

24 through-hole

25 workpiece

26 fiber

28 fiber surface

30 fiber bundle

32 weight

34 guide slot in guide sleeve

36 axis of rotation

38 opening surface to be deburred

42 stop

44 stop ring

46 stop sleeve

50 guide pin

52 pivot bearing

T depth of the through-hole

L1 length of the fiber

L2 length of the guide sleeve

R rotational movement

1. A deburring tool for deburring at least one through-hole in a workpiece, an opening surface of the through-hole to be deburred being arranged on a side facing away from the deburring tool, comprising a main body having a tool shaft and a tool head, the tool shaft comprising a clamping section, the tool head comprising a guide section having a guide sleeve extending along or parallel to an axis of rotation, the tool head has at least one flexible fiber having an abrasive fiber surface which is permanently or detachably fixed in the guide sleeve, wherein the fiber has a free length and the guide sleeve has a length, wherein the free length and/or the length corresponds at least to a depth of the through-hole.

2. The deburring tool according to claim 1, wherein the fiber is guided within the guide sleeve along the axis of rotation.

3. The deburring tool according to claim 1, wherein at least two flexible fibers are guided in the guide sleeve parallel to the axis with respect to the axis of rotation.

4. The deburring tool according to claim 1, wherein at least three fibers are arranged about the axis of rotation in a circumferential direction in an evenly distributed manner about the axis of rotation on the guide sleeve.

5. The deburring tool according to claim 1, wherein the fiber is formed at least in sections as a plastic fiber, glass fiber, metal fiber, ceramic fiber and/or carbon fiber.

6. The deburring tool according to claim 1, wherein the fiber is configured as a bundle of individual filaments, or as an individual filament.

7. The deburring tool according to claim 1, wherein the fiber surface of the fiber is configured structured or textured in order to provide the abrasive effect on contact with the workpiece.

8. The deburring tool according to claim 1, wherein a weight is fastened to a front end of the fiber.

9. The deburring tool according to claim 1, wherein the length of the guide sleeve is changeably adjustable.

10. The deburring tool according to claim 1, wherein the at least one fiber is exchangeably mounted in the guide sleeve.

11. The deburring tool according to claim 1, wherein a stop is arranged on the guide section, which stop can execute a rotational movement relative to the guide sleeve, wherein the stop has a larger diameter than a largest diameter of the through-hole.

12. The deburring tool according to claim 11, wherein the stop has a stop ring and a stop sleeve.

13. The deburring tool according to claim 12, wherein the stop ring can execute a rotational movement with respect to the stop sleeve, wherein the stop sleeve is preferably mounted in a rotationally fixed manner with the guide sleeve and the stop ring is preferably mounted with the stop sleeve via a pivot bearing.

14. The deburring tool according to claim 11, wherein the stop and the guide sleeve can be displaced relative to one another in the axial direction to the axis of rotation.

15. The deburring tool according to claim 14, wherein the stop has a stop ring and a stop sleeve 4nd an axial guidance of the stop sleeve takes place along the guide sleeve by a guide pin which is arranged radially on the stop sleeve and a guide slot, wherein the guide pin engages in the guide slot.

16. A method for deburring using a deburring tool according to claim 1, comprising the following steps:
inserting the deburring tool into a through-hole from an opposite side of the workpiece with respect to an opening surface to be deburred, wherein at least the fiber partially protrudes from the through-hole on the opening surface to be deburred,
rotating the deburring tool to a nominal speed, wherein the at least one fiber preferably strives away at right angles with respect to the guide sleeve due to centrifugal force,
pulling the deburring tool out of the through-hole during the rotational movement of the deburring tool, so that deburring is effected on the opening surface of the through-hole, wherein the deburring angle depends on speed and longitudinal movement of the deburring tool.

17. The method for deburring using a deburring tool according to claim 16, wherein during the rotational movement about the axis of rotation, the fiber surface of the fiber comes into contact with the opening surface of the through-hole to be deburred, wherein a deburring effect takes place through the fiber surface.

18. The method for deburring using a deburring tool according to claim 17, wherein the speed of the deburring tool determines tensile stress in the fiber.

19. The method for deburring using a deburring tool according to claim 16, wherein the workpiece is a plastic, composite fiber or lightweight board.

20. The deburring tool according to claim 3, wherein both fibers have the same free length.

21. The deburring tool according to claim 4, wherein four to seven fibers are arranged about the axis of rotation in the circumferential direction in an evenly distributed manner about the axis of rotation on the guide sleeve, and all fibers have the same length.

22. The deburring tool according to claim 8, wherein a cross-sectional size of the weight is less than or equal to a cross-sectional size of the fiber.

23. The deburring tool according to claim 1, wherein a length of the guide sleeve is telescopically changeable in length.

24. The deburring tool according to claim 13, wherein the stop sleeve is mounted in a rotationally fixed manner with the guide sleeve, and the stop ring is mounted with the stop sleeve via a pivot bearing.

25. The deburring tool according to claim 15, wherein the guide slot is introduced in an axial longitudinal direction on the guide sleeve.
